(19) United States
(12) Patent Application Publication
(10) Pub. No.: US 2025/0383691 A1
(43) Pub. Date: Dec. 18, 2025

(54) HINGE ASSEMBLY AND FOLDABLE DISPLAY DEVICE INCLUDING THE SAME

(71) Applicant: Samsung Display Co., Ltd., Yongin-si (KR)

(72) Inventor: SUNGSANG AHN, Yongin-si (KR)

(73) Assignee: Samsung Display Co., Ltd., Yongin-si (KR)

(21) Appl. No.: 19/083,755

(22) Filed: Mar. 19, 2025

(30) Foreign Application Priority Data
Jun. 14, 2024 (KR) 10-2024-0077505

(51) Int. Cl. G06F 1/16

(52) U.S. Cl. CPC G06F 1/1681; G06F 1/1652

(57) ABSTRACT

A hinge assembly includes a first support bar extending in a first direction, a second support bar extending in the first direction, and a first rotation guide device connecting the first support bar and the second support bar. The first rotation guide device includes a guide member including a guide slot, a first rotational bar having an end coupled to the first support bar and another end inserted into the guide slot and slidable along the guide slot, a second rotational bar having an end coupled to the second support bar and another end coupled to the guide member, and a clip spring coupled to the guide member. The guide slot has an arc shape centered on a first axis parallel to the first direction, and the clip spring is coupled to the guide member and presses the another end of the first rotational bar from both sides.

### CROSS-REFERENCE TO RELATED APPLICATION(S)

This U.S. application claims priority to and benefits of Korean Patent Application No. 10-2024-0077505 under 35 U.S.C. § 119, filed on Jun. 14, 2024, in the Korean Intellectual Property Office (KIPO), the entire contents of which are incorporated herein by reference.

### BACKGROUND

### 1. Technical Field

The disclosure herein relates to a hinge assembly and a foldable display device including the same.

### 2. Description of the Related Art

Electronic devices such as smartphones, digital cameras, notebook computers, navigation devices and smart televisions, which provide images for users, include display devices for displaying images. The display devices generate images and provide users with the generated images through display screens.

Recently, with the technical development for the display devices, display devices having various shapes are developed. For example, various flexible display devices capable of being changed into curved shapes or being foldable or rollable are developed. The flexible display devices may be portable and improve users' convenience. There are foldable display devices capable of folding displays as one kind of flexible display devices.

### SUMMARY

The disclosure provides a hinge assembly reduced in thickness and capable of performing a natural operation, and a foldable display device including the hinge assembly.

According to an embodiment of the disclosure, a hinge assembly may include a first support bar extending in a first direction, a second support bar extending in the first direction, and a first rotation guide device that connects the first support bar and the second support bar to each other. The first rotation guide device may include a guide member including a guide slot, a first rotational bar having an end fixed and coupled to the first support bar and another end inserted into the guide slot and slidable along the guide slot, a second rotational bar having an end fixed and coupled to the second support bar and another end coupled to the guide member, and a clip spring coupled to the guide member. The guide slot may have an arc shape centered on a first axis parallel to the first direction, and the clip spring may be coupled to the guide member and press the another end of the first rotational bar from both sides on a basis of the guide slot.

In an embodiment of the disclosure, the clip spring may include a metal.

In an embodiment of the disclosure, the clip spring may include a first pressing end that presses a side surface of the another end of the first rotational bar, a second pressing end that presses another side surface of the another end of the first rotational bar, and a connecting plate that connects the first pressing end and the second pressing end to each other.

In an embodiment of the disclosure, the clip spring may have a ring shape having an open side.

In an embodiment of the disclosure, the another end of the second rotational bar may be fixed and coupled to the guide member in a state of being inserted into the guide slot.

In an embodiment of the disclosure, a shape of the first rotational bar and a shape of the second rotational bar may be same.

In an embodiment of the disclosure, the guide member may include a first member including a first slot having an arc shape centered on the first axis, and a second member including a second slot having an arc shape centered on the first axis. The first member and the second member may be separable from each other, and the first member and the second member may constitute the guide slot.

In an embodiment of the disclosure, the another end of the first rotational bar may be disposed between the first member and the second member, a side of the another end of the first rotational bar may be inserted into the first slot, and another side of the another end of the first rotational bar may be inserted into the second slot.

In an embodiment of the disclosure, the first axis may be spaced apart upward from a top surface of the end of the first rotational bar, and a distance between the first axis and the another end of the first rotational bar may be greater than a distance between the top surface of the end of the first rotational bar and the another end of the first rotational bar.

In an embodiment of the disclosure, the hinge assembly may further include a third support bar extending in the first direction, and a second rotation guide device that connects the second support bar and the third support bar to each other.

In an embodiment of the disclosure, a foldable display device may include a first support part, a second support part rotatable with respect to the first support part, and a hinge assembly that connects the first support part and the second support part to each other. The hinge assembly may include a first support bar coupled to the first support part and extending in a first direction, a second support bar disposed between the first support bar and the second support part and extending in the first direction, and a first rotation guide device that connects the first support bar and the second support bar to each other. The first rotation guide device may include a guide member including a guide slot, a first rotational bar having an end fixed and coupled to the first support bar and another end inserted into the guide slot and movable along the guide slot, and a second rotational bar having an end fixed and coupled to the second support bar and another end inserted into the guide slot. The guide member may be spaced apart from the first rotational bar and the second rotational bar in a direction intersecting the first direction. The guide slot may have an arc shape centered on a first axis parallel to the first direction.

In an embodiment of the disclosure, the foldable display device may further include a display coupled onto a top surface of the first support part and a top surface of the second support part.

In an embodiment of the disclosure, the first rotation guide device may further include a clip spring coupled to the guide member, and the clip spring may be coupled to the guide member and press the another end of the first rotational bar from both sides on a basis of the guide slot.

In an embodiment of the disclosure, the foldable display device may further include a flexible cover between the first support part and the second support part. The flexible cover may cover the hinge assembly.

In an embodiment of the disclosure, the first axis may be defined above a top surface of the end of the first rotational bar.

In an embodiment of the disclosure, an electronic device may include a display device including a display element layer disposed on a substrate, and a hinge assembly including a first support bar extending in a first direction, a second support bar extending in the first direction, and a first rotation guide device that connects the first support bar and the second support bar to each other. The first rotation guide device may include a guide member including a guide slot, a first rotational bar having an end fixed and coupled to the first support bar and another end inserted into the guide slot and slidable along the guide slot, a second rotational bar having an end fixed and coupled to the second support bar and another end coupled to the guide member, and a clip spring coupled to the guide member. The guide slot may have an arc shape centered on a first axis parallel to the first direction, and the clip spring may be coupled to the guide member and press the another end of the first rotational bar from both sides on a basis of the guide slot.

In an embodiment, the electronic device may be at least one of a mobile phone, a smartphone, a portable computer, a tablet personal computer (PC), a portable multimedia player (PMP), a navigation system, and an ultra mobile computer (UMPC).

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain principles of the disclosure. In the drawings:

FIG. 1 is a perspective view illustrating a foldable display device according to an embodiment of the disclosure;

FIG. 2 is a partial exploded perspective view illustrating a foldable display device according to an embodiment of the disclosure;

FIG. 3 is a perspective view illustrating a hinge assembly according to an embodiment of the disclosure;

FIG. 4 is an enlarged perspective view illustrating a hinge assembly according to an embodiment of the disclosure;

FIG. 5 is a perspective view illustrating a rotation guide device according to an embodiment of the disclosure;

FIG. 6 is an exploded perspective view illustrating a rotation guide device according to an embodiment of the disclosure;

FIG. 7 is a front view illustrating a rotation guide device according to an embodiment of the disclosure;

FIG. 8 is an exploded front view illustrating a rotation guide device according to an embodiment of the disclosure;

FIGS. 9 and 10 are side views illustrating a rotation guide device according to an embodiment of the disclosure; and

FIGS. 11 and 12 are perspective views illustrating a use state of a foldable display device according to an embodiment of the disclosure.

### DETAILED DESCRIPTION OF THE EMBODIMENTS

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Also, when an element is referred to as being “in contact” or “contacted” or the like to another element, the element may be in “electrical contact” or in “physical contact” with another element; or in “indirect contact” or in “direct contact” with another element.

Like reference numbers or symbols refer to like elements throughout. In addition, in the drawings, the thickness, the ratio, and the dimension of elements are exaggerated for effective description of the technical contents. The term “and/or” includes one or more combinations which may be defined by relevant elements.

It will be understood that, although the terms first, second, etc. may be used herein to describe various elements, these elements should not be limited by these terms. These terms are only used to distinguish one element from another element. For example, a first element could be termed a second element without departing from the teachings of the disclosure, and similarly, a second element could be termed a first element. As used herein, the singular forms are intended to include the plural forms as well, unless the context clearly indicates otherwise.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

In the specification and the claims, the phrase “at least one of” is intended to include the meaning of “at least one selected from the group of” for the purpose of its meaning and interpretation. For example, “at least one of A and B” may be understood to mean “A, B, or A and B.” In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a display device according to an embodiment of the disclosure will be described with reference to the accompanying drawings.

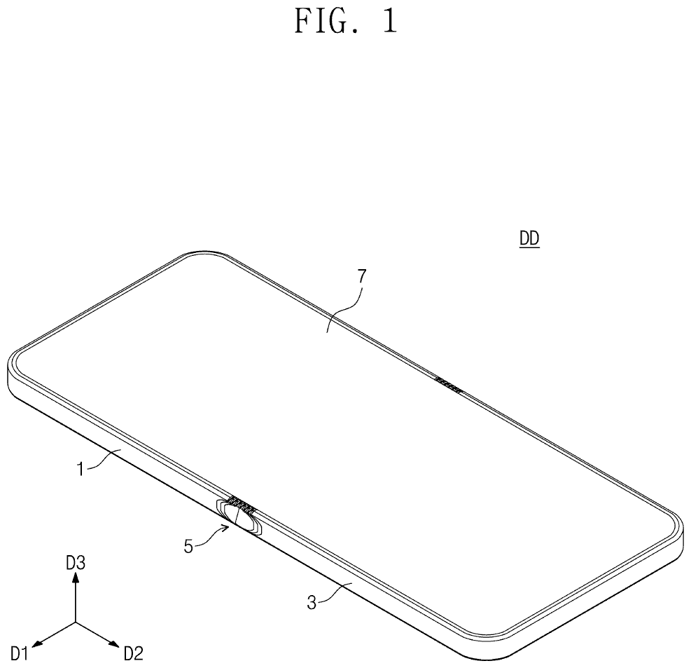

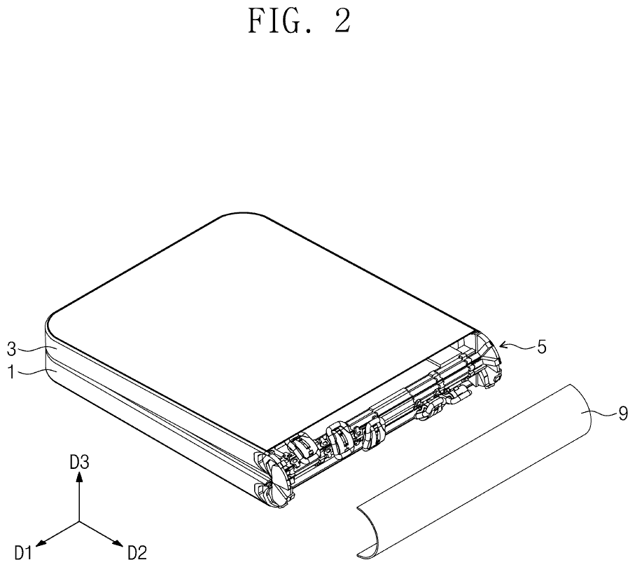

FIG. 1 is a perspective view illustrating a foldable display device according to an embodiment of the disclosure. FIG. 2 is a partial exploded perspective view illustrating a foldable display device according to an embodiment of the disclosure.

Hereinafter, D1 may be termed a first direction, D2 intersecting the first direction D1 may be termed a second direction, and D3 intersecting each of the first direction D1 and the second direction D2 may be termed a third direction.

Referring to FIGS. 1 and 2, a foldable display device DD may be provided. The foldable display device DD may be a display device capable of being folded or bent. For example, the foldable display device DD may be a smartphone capable of being folded and/or a tablet computer capable of being folded. The foldable display device DD may include a first support part 1, a second support part 3, a display 7, a hinge assembly 5, and a flexible cover 9.

The first support part 1 may support the display 7. For example, the first support part 1 may support a portion of the display 7. The portion of the display 7 may be supported by the first support part 1 in a state of being coupled on a top surface of the first support part 1. A housing of the first support part 1 may include a rigid material. The first support part 1 may have a rectangular shape, but the disclosure is not limited thereto.

The second support part 3 may support the display 7. For example, the second support part 3 may support another portion of the display 7. The another portion of the display 7 may be supported by the second support part 3 in a state of being coupled on a top surface of the second support part 3. A housing of the second support part 3 may include a rigid material. The second support part 3 may have a rectangular shape, but the disclosure is not limited thereto. The second support part 3 may be connected to the first support part 1. For example, the second support part 3 may be connected to the first support part 1 by using the hinge assembly 5 as a medium. The second support part 3 may be rotatable with respect to the first support part 1. For example, the second support part 3 may relatively rotate with respect to the first support part 1 through the hinge assembly 5.

The display 7 may be coupled onto the top surface of the first support part 1 and the top surface of the second support part 3. The display 7 may have a rectangular shape in a plan view. The display 7 may be supported by the first support part 1 and the second support part 3. As the second support part 3 rotates with respect to the first support part 1, the display 7 may be bent or folded. For this, the display 7 may include a flexible display. For example, the display 7 may include an organic light emitting display panel or an electrophoretic display panel, but the disclosure is not limited thereto.

The hinge assembly 5 may connect the first support part 1 and the second support part 3 to each other. For this, a side of the hinge assembly 5 may be coupled to the first support part 1. Another side of the hinge assembly 5 may be coupled to the second support part 3. The second support part 3 may rotate with respect to the first support part 1 through the hinge assembly 5. The hinge assembly 5 may have a multi-axis structure. For example, the hinge assembly 5 may be rotatable around several virtual axes. Accordingly, the display 7 may be smoothly foldable or bendable. The hinge assembly 5 will be described below in more detail.

The flexible cover 9 may be disposed between the first support part 1 and the second support part 3. The flexible cover 9 may cover the hinge assembly 5. The flexible cover 9 may include a flexible material. Accordingly, in case that the second support part 3 rotates with respect to the first support part 1, the flexible cover 9 may be also bent.

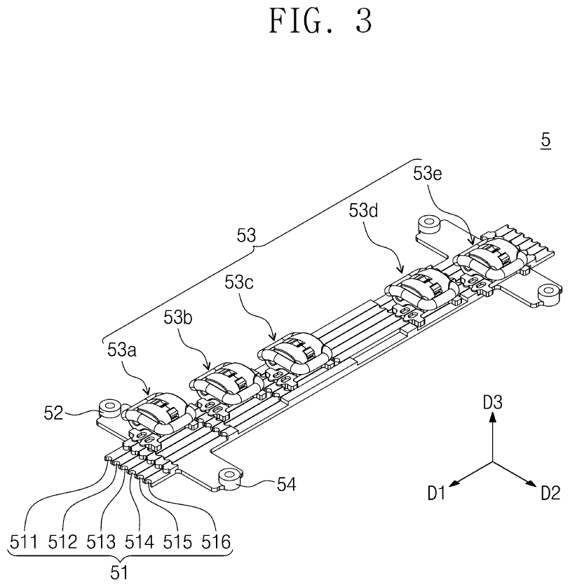

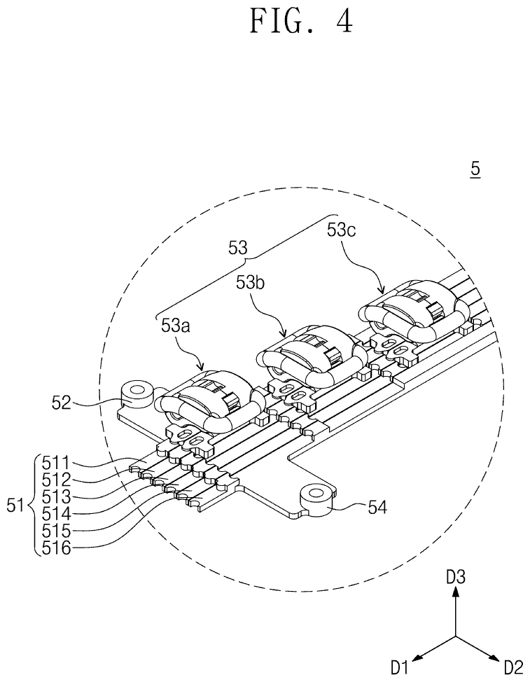

FIG. 3 is a perspective view illustrating a hinge assembly according to an embodiment of the disclosure. FIG. 4 is an enlarged perspective view illustrating a hinge assembly according to an embodiment of the disclosure.

Referring to FIGS. 3 and 4, a hinge assembly 5 may include a support bar 51, a rotation guide device 53, a first connecting part 52, and a second connecting part 54.

The support bar 51 may extend in the first direction D1. The support bar 51 may be in the form of, for example, a bar having a rectangular cross-section, but the disclosure is not limited thereto. The support bar 51 may be provided in plurality. The support bars 51 may be arranged in the second direction D2. The number of the support bars 51 may be, for example, six as illustrated in FIG. 3. For example, the hinge assembly 5 may include a first support bar 511, a second support bar 512, a third support bar 513, a fourth support bar 514, a fifth support bar 515, and a sixth support bar 516. However, the disclosure is not limited thereto, and the number of the support bars 51 may be two, three, four, five, or six or more. Two neighboring support bars 51 of the support bars 51 may be connected to each other by the rotation guide device 53. The two neighboring support bars 51 of the support bars 51 may be movable with respect to each other. This will be described below in more detail. Hereinafter, one of the support bars 51 will be described for concise description unless a special case.

The rotation guide device 53 may connect the two neighboring support bars 51 of the support bars 51 to each other. For example, a side of the rotation guide device 53 may be coupled to one of the two neighboring support bars 51. Another side of the rotation guide device 53 may be coupled to another one of the two neighboring support bars 51. The two neighboring support bars 51 may be rotatively movable with respect to each other by the rotation guide device 53. This will be described below in more detail. The rotation guide device 53 may be provided in plurality. The number of the rotation guide devices 53 may be one less than the number of the support bars 51. For example, in case that the number of the support bars 51 is six, the number of the rotation guide devices 53 may be five. For example, the hinge assembly 5 may include a first rotation guide device 53a, a second rotation guide device 53b, a third rotation guide device 53c, a fourth rotation guide device 53d, and a fifth rotation guide device 53e. For example, the first rotation guide device 53a may connect the first support bar 511 and the second support bar 512 to each other. However, the disclosure is not limited thereto, and the number of the rotation guide devices 53 may be two, three, four, or six or more. The rotation guide devices 53 may have a same shape, but the disclosure is not limited thereto. Hereinafter, one of the rotation guide device 53 will be described for concise description unless a special case. The rotation guide device 53 will be described below in more detail.

The first connecting part 52 may connect the support bar 51 and the first support part 1 (see FIG. 1) to each other. For example, the first connecting part 52 may connect the first support bar 511 and the first support part 1. For example, a side of the first connecting part 52 may be coupled to the first support bar 511, and another side of the first connecting part 52 may be coupled to the first support part 1. The first connecting part 52 may be fixed and coupled to the first support part 1 through a separate coupling means (not illustrated) such as bolt. For this, the first connecting part 52 may include a first coupling means hole (no reference symbol shown), but the disclosure is not limited thereto.

The second connecting part 54 may connect the support bar 51 and the second support part 3 (see FIG. 1) to each other. For example, the second connecting part 54 may connect the sixth support bar 516 and the second support part 3. For example, a side of the second connecting part 54 may be coupled to the sixth support bar 516, and another side of the second connecting part 54 may be coupled to the second support part 3. The second connecting part 54 may be fixed and coupled to the second support part 3 through a separate coupling means (not illustrated) such as bolt. For this, the second connecting part 54 may include a second coupling means hole (no reference symbol shown), but the disclosure is not limited thereto.

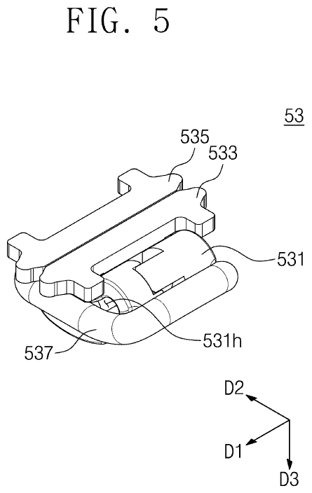

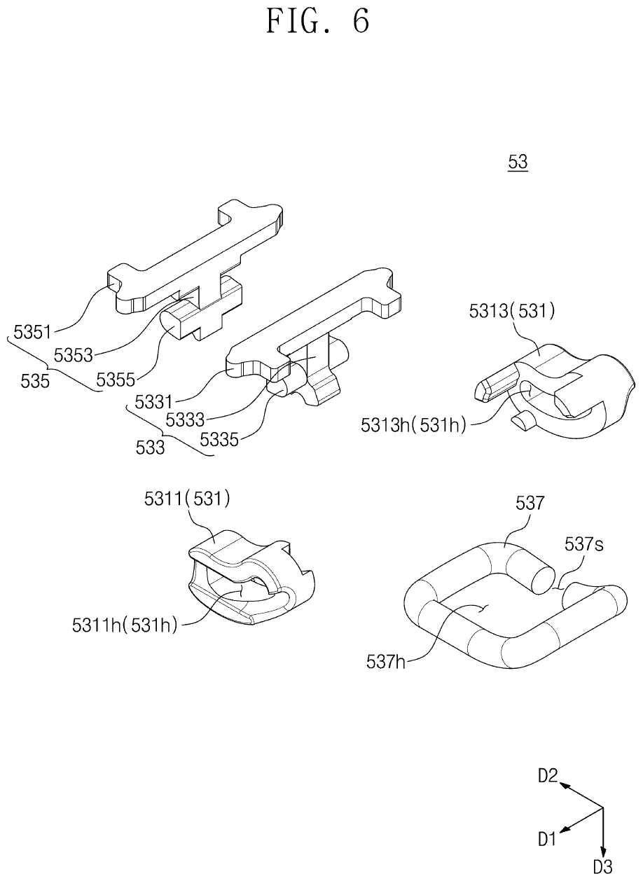

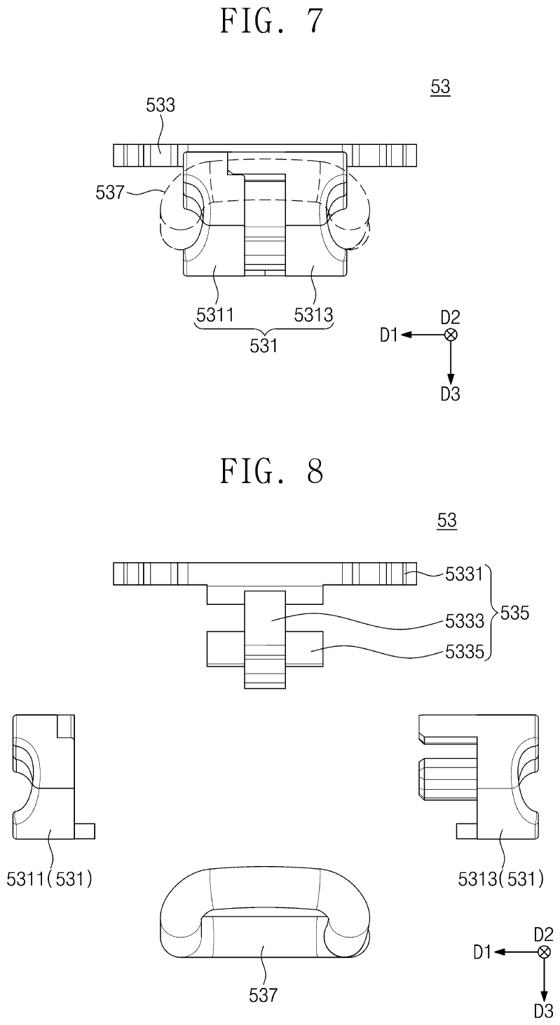

FIG. 5 is a perspective view illustrating a rotation guide device according to an embodiment of the disclosure. FIG. 6 is an exploded perspective view illustrating a rotation guide device according to an embodiment of the disclosure. FIG. 7 is a front view illustrating a rotation guide device according to an embodiment of the disclosure. FIG. 8 is an exploded front view illustrating a rotation guide device according to an embodiment of the disclosure.

Referring to FIGS. 5, 6, 7, and 8, a rotation guide device 53 may include a guide member 531, a first rotational bar 533, a second rotational bar 535, and a clip spring 537.

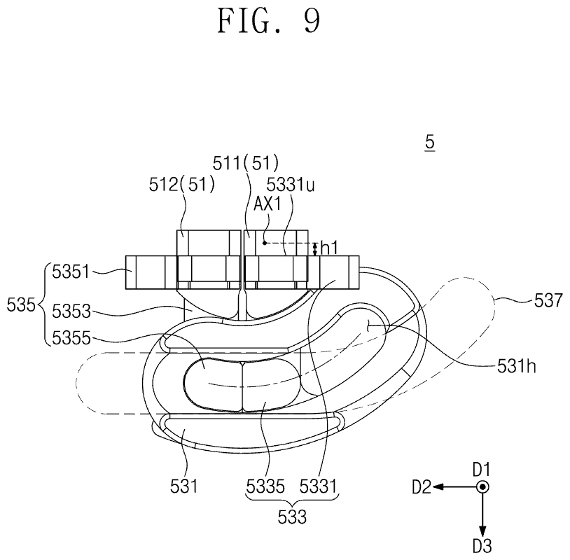

The guide member 531 may include a guide slot 531h. The guide slot 531h may pass through the guide member 531. For example, the guide slot 531h may extend in the first direction D1 and connect two side surfaces of the guide member 531 to each other. The guide slot 531h may have a curve shape in a cross-sectional view. For example, the guide slot 531h may have a curve shape centered on a first axis AX1 (see FIG. 9) parallel to the first direction D1. The first axis AX1 may be a virtual axis. For example, the guide slot 531h may have an arc shape centered on the first axis AX1. The first axis AX1 that is a center of the guide slot 531h may be defined outside the first rotational bar 533. For example, the first axis AX1 may be defined above the first rotational bar 533. This will be described below in more detail. The guide member 531 may be spaced apart from a first support bar 511 (see FIG. 9) and a second support bar 512 (see FIG. 9) in the third direction D3. Accordingly, the guide slot 531h may also be spaced apart from the support bar 51 in the third direction D3. Accordingly, the guide member 531 may rotatively move outside the support bar 51. This will be described later in more detail. The guide member 531 may be separable into two or more members. For example, as illustrated in FIG. 6, the guide member 531 may include a first member 5311 and a second member 5313. The first member 5311 and the second member 5313 may be coupled to constitute one guide member 531. The first member 5311 may include a first slot 5311h. The first member 5311 may have an arc shape centered on the first axis AX1 (see FIG. 9). The second member 5313 may include a second slot 5313h. The second slot 5313h may have an arc shape centered on the first axis AX1 (see FIG. 9). The first slot 5311h and the second slot 5313h may constitute one guide slot 531h.

The first rotational bar 533 may connect the first support bar 511 (see FIG. 9) and the guide member 531 to each other. For this, an end 5331 of the first rotational bar 533 may be fixed and coupled to the first support bar 511. Another end 5335 of the first rotational bar 533 may be connected to the guide member 531. For example, the another end 5335 of the first rotational bar 533 may be inserted into the guide slot 531h. The first rotational bar 533 may be slidable along the guide slot 531h. The end 5331 of the first rotational bar 533 may be also termed a first upper member 5331. The another end 5335 of the first rotational bar 533 may be also termed a first lower member 5335. The first rotational bar 533 may further include a first connecting member 5333. The first connecting member 5333 may connect the first upper member 5331 and the first lower member 5335 to each other. The another end 5335 of the first rotational bar 533 may be disposed between the first member 5311 and the second member 5313. For example, a side of the first lower member 5335 may be inserted into the first slot 5311h. Another side of the first lower member 5335 may be inserted into the second slot 5313h.

The second rotational bar 535 may connect the second support bar 512 (see FIG. 9) and the guide member 531 to each other. For this, an end 5351 of the second rotational bar 535 may be fixed and coupled to the second support bar 512. Another end 5355 of the second rotational bar 535 may be connected to the guide member 531. For example, the another end 5355 of the second rotational bar 535 may be inserted into the guide slot 531h. The second rotational bar 535 may not slide along the guide slot 531h. For example, the second rotational bar 535 may be fixed and coupled to the guide member 531. Thus, a component that moves in one rotation guide device 53 may be only the first rotational bar 533. For example, a degree of freedom of the rotation guide device 53 may be 1. Accordingly, a movement of the rotation guide device 53 may be accurately controlled. The end 5351 of the second rotational bar 535 may be also termed a second upper member 5351. The another end 5355 of the second rotational bar 535 may be also termed a second lower member 5355. The second rotational bar 535 may further include a second connecting member 5353. The second connecting member 5353 may connect the second upper member 5351 and the second lower member 5355 to each other. The another end 5355 of the second rotational bar 535 may be disposed between the first member 5311 and the second member 5313. For example, a side of the second lower member 5355 may be inserted into the first slot 5311h. Another side of the second lower member 5355 may be inserted into the second slot 5313h. A shape of the second rotational bar 535 and a shape of the first rotational bar 533 may be substantially the same or similar, but the disclosure is not limited thereto.

The clip spring 537 may be coupled to the guide member 531. The clip spring 537 may press the first rotational bar 533. For example, the clip spring 537 may press the first lower member 5335 to apply resistance to the sliding movement of the first rotational bar 533 with respect to the guide member 531. For this, the clip spring 537 may be coupled to the guide member 531 so as to press the another end 5335 of the first rotational bar 533 from both sides on the basis of the guide slot 531h. For this, the clip spring 537 may include a material having an elastic restoring force. For example, the clip spring 537 may include a metal. The clip spring 537 may have various shapes. For example, the clip spring 537 may have a ring shape having an open side. For example, the clip spring 537 having a ring shape may include a center hole 537h passing through a center of the clip spring 537. Also, the clip spring 537 may further include an opening hole 537s in a side surface of the clip spring 537. The clip spring 537 having a ring shape may surround the guide member 531. For example, the clip spring 537 having a ring shape having an open side may surround the guide slot 531h and press the another end 5335 of the first rotational bar 533, which is inserted into the guide slot 531h, from both sides. Accordingly, the sliding movement of the first rotational bar 533 with respect to the guide member 531 may be constrained. As above, the clip spring 537 is illustrated and described as having a ring shape, but the disclosure is not limited thereto. For example, the clip spring 537 may have a U-shaped clip structure. In an embodiment, the clip spring 537 may include a first pressing end which presses a side surface of the another end 5335 of the first rotational bar 533, a second pressing end which presses another side surface of the another end 5335 of the first rotational bar 533, and a connecting plate which connects the first pressing end and the second pressing end to each other. In another embodiment, the clip spring 537 may have another structure capable of pressing the first rotational bar 533 and/or the second rotational bar 535 by using an elastic restoring force.

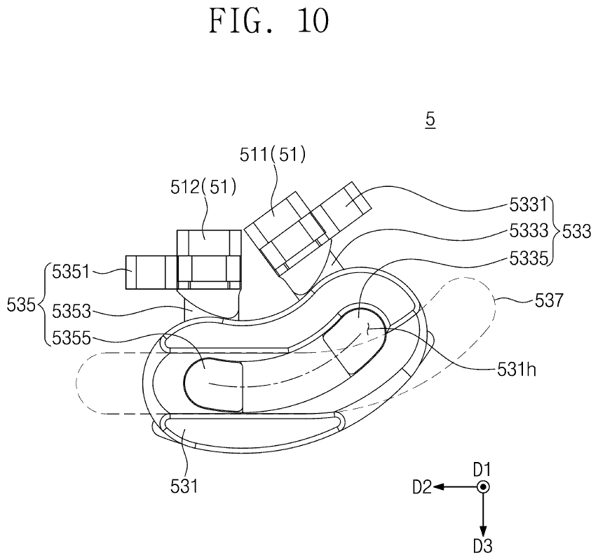

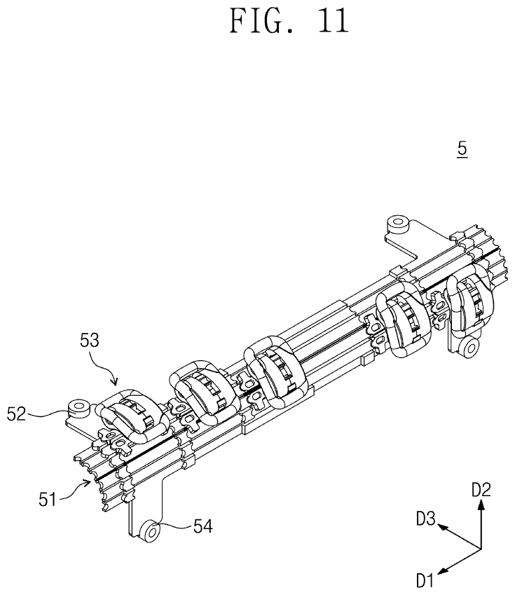

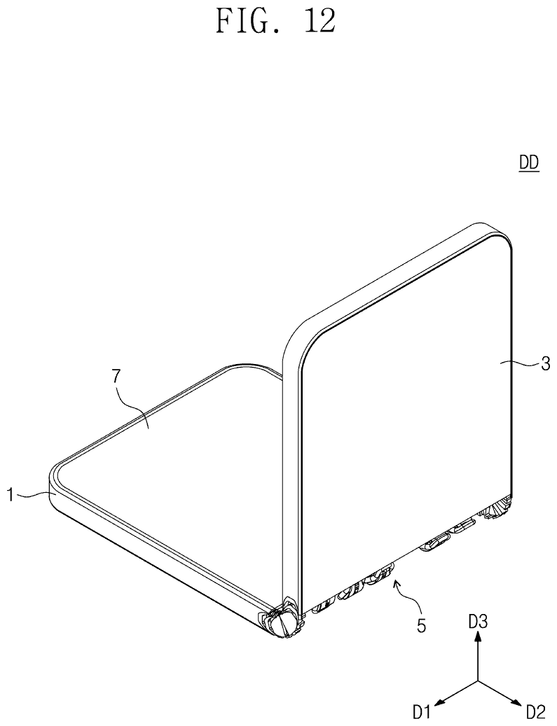

FIGS. 9 and 10 are side views illustrating a rotation guide device according to an embodiment of the disclosure. FIGS. 11 and 12 are perspective views illustrating a use state of a foldable display device according to an embodiment of the disclosure.

Referring to FIGS. 9, 10, 11, and 12, a first axis AX1 that is a center axis of a shape of a guide slot 531h may be defined outside a first rotational bar 533. For example, the first axis AX1 may be defined above a top surface 5331u of the end 5331 of the first rotational bar 533. For example, the first axis AX1 may be spaced apart upward from the top surface 5331u of the end 5331 of the first rotational bar 533 such that a distance between the first axis AX1 and the another end 5335 of the first rotational bar 533 is greater than a distance between the top surface 5331u of the end 5331 of the first rotational bar 533 and the another end 5335 of the first rotational bar 533. A spaced distance between the first axis AX1 and the top surface 5331u of the end 5331 of the first rotational bar 533 may be termed a first distance h1. The first distance h1 may be in a range of about 0.01 mm to about 5.00 mm. As the first axis AX1 that serves as a center of rotation of the first rotational bar 533 is defined above the first rotational bar 533, in case that the first rotational bar 533 rotates with respect to a second rotational bar 535, natural movement may be performed without interference between the first rotational bar 533 and the second rotational bar 535.

Referring to FIGS. 9 and 10, the first rotational bar 533 may be rotatively movable along a guide slot 531h. For example, the first rotational bar 533 may relatively move with respect to the second rotational bar 535. Accordingly, a first support bar 511 coupled to the first rotational bar 533 may be relatively movable with respect to a second support bar 512. Thus, as illustrated in FIGS. 11 and 12, a second support part 3 may relatively rotate with respect to a first support part 1. Accordingly, the display 7 may be foldable or bendable.

As above, the embodiments are illustrated and described based on a flip-type smartphone, but the disclosure is not limited thereto. For example, the hinge assembly and the foldable display device including the same according to an embodiment of the disclosure may be also applied to a fold-type smartphone and/or tablet computer. For example, the hinge assembly may be applied to at least one of a mobile phone, a smartphone, a portable computer, a tablet personal computer (PC), a portable multimedia player (PMP), a navigation system, and an ultra mobile computer (UMPC)

According to the hinge assembly and the foldable display device including the same according to the embodiments of the disclosure, as the hinge assembly having a multi-axis structure is used, an overall thickness of the foldable display device may be reduced. The multi-axis structure may be used to achieve various curvatures. Accordingly, a design may be improved.

According to the hinge assembly and the foldable display device including the same according to the embodiments of the disclosure, the axis that serves as the center of rotation may be defined outside the first rotational bar. Thus, in case that the first rotational bar rotates, interference and/or collision with another surrounding component may be prevented. Accordingly, a natural rotating operation may be performed.

According to the hinge assembly and the foldable display device including the same according to the embodiments of the disclosure, the rotation of the foldable display device may be constrained using the clip spring. Accordingly, even in a state in which the foldable display device is not completely folded or unfolded, the foldable display device may be maintained in a shape. For example, as the operation of the hinge assembly is controlled using the elastic restoring force of the clip spring, in a state in which the foldable display device is partially folded at a specific angle, the foldable display device may be fixed in the shape.

According to the hinge assembly and the foldable display device including the same according to the embodiments of the disclosure, the thickness of the entire device may be reduced.

According to the hinge assembly and the foldable display device including the same according to the embodiments of the disclosure, the natural operation may be performed.

According to the hinge assembly and the foldable display device including the same according to the embodiments of the disclosure, the rotation of the foldable display device may be controlled.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A hinge assembly comprising:
a first support bar extending in a first direction;
a second support bar extending in the first direction; and
a first rotation guide device that connects the first support bar and the second support bar to each other, wherein
the first rotation guide device comprises:
a guide member including a guide slot;
a first rotational bar having an end fixed and coupled to the first support bar and another end inserted into the guide slot and slidable along the guide slot;
a second rotational bar having an end fixed and coupled to the second support bar and another end coupled to the guide member; and
a clip spring coupled to the guide member,
the guide slot has an arc shape centered on a first axis parallel to the first direction, and
the clip spring is coupled to the guide member and presses the another end of the first rotational bar from both sides on a basis of the guide slot.

2. The hinge assembly of claim 1, wherein the clip spring comprises a metal.

3. The hinge assembly of claim 1, wherein the clip spring comprises:
a first pressing end that presses a side surface of the another end of the first rotational bar;
a second pressing end that presses another side surface of the another end of the first rotational bar; and
a connecting plate that connects the first pressing end and the second pressing end to each other.

4. The hinge assembly of claim 1, wherein the clip spring has a ring shape having an open side.

5. The hinge assembly of claim 1, wherein the another end of the second rotational bar is fixed and coupled to the guide member in a state of being inserted into the guide slot.

6. The hinge assembly of claim 1, wherein a shape of the first rotational bar and a shape of the second rotational bar are same.

7. The hinge assembly of claim 1, wherein
the guide member comprises:
a first member including a first slot having an arc shape centered on the first axis; and
a second member including a second slot having an arc shape centered on the first axis,
the first member and the second member are separable from each other, and
the first member and the second member constitute the guide slot.

8. The hinge assembly of claim 7, wherein
the another end of the first rotational bar is disposed between the first member and the second member,
a side of the another end of the first rotational bar is inserted into the first slot, and
another side of the another end of the first rotational bar is inserted into the second slot.

9. The hinge assembly of claim 1, wherein
the first axis is spaced apart upward from a top surface of the end of the first rotational bar, and
a distance between the first axis and the another end of the first rotational bar is greater than a distance between the top surface of the end of the first rotational bar and the another end of the first rotational bar.

10. The hinge assembly of claim 1, further comprising:
a third support bar extending in the first direction; and
a second rotation guide device that connects the second support bar and the third support bar to each other.

11. A foldable display device comprising:
a first support part;
a second support part rotatable with respect to the first support part; and
a hinge assembly that connects the first support part and the second support part to each other, wherein
the hinge assembly comprises:
a first support bar coupled to the first support part and extending in a first direction;
a second support bar disposed between the first support bar and the second support part and extending in the first direction; and
a first rotation guide device that connects the first support bar and the second support bar to each other,
the first rotation guide device comprises:
a guide member including a guide slot;
a first rotational bar having an end fixed and coupled to the first support bar and another end inserted into the guide slot and movable along the guide slot; and
a second rotational bar having an end fixed and coupled to the second support bar and another end inserted into the guide slot,
the guide member is spaced apart from the first rotational bar and the second rotational bar in a direction intersecting the first direction, and
the guide slot has an arc shape centered on a first axis parallel to the first direction.

12. The foldable display device of claim 11, further comprising:
a display coupled onto a top surface of the first support part and a top surface of the second support part.

13. The foldable display device of claim 11, wherein
the first rotation guide device further comprises a clip spring coupled to the guide member, and
the clip spring is coupled to the guide member and presses the another end of the first rotational bar from both sides on a basis of the guide slot.

14. The foldable display device of claim 11, further comprising:
a flexible cover between the first support part and the second support part,
wherein the flexible cover covers the hinge assembly.

15. The foldable display device of claim 11, wherein the first axis is defined above a top surface of the end of the first rotational bar.

16. An electronic device comprising:
a display device including a display element layer disposed on a substrate; and
a hinge assembly, comprising
a first support bar extending in a first direction;
a second support bar extending in the first direction; and
a first rotation guide device that connects the first support bar and the second support bar to each other, wherein
the first rotation guide device comprises:
a guide member including a guide slot;
a first rotational bar having an end fixed and coupled to the first support bar and another end inserted into the guide slot and slidable along the guide slot;
a second rotational bar having an end fixed and coupled to the second support bar and another end coupled to the guide member; and
a clip spring coupled to the guide member,
the guide slot has an arc shape centered on a first axis parallel to the first direction, and
the clip spring is coupled to the guide member and presses the another end of the first rotational bar from both sides on a basis of the guide slot.

17. The electronic device of claim 16, wherein the electronic device is at least one of a mobile phone, a smartphone, a portable computer, a tablet personal computer (PC), a portable multimedia player (PMP), a navigation system, and an ultra mobile computer (UMPC).
